(19) United States
(12) Patent Application Publication
(10) Pub. No.: US 2011/0013738 A1
(43) Pub. Date: Jan. 20, 2011

(54) Neutron Source For Creation of Isotopes

(76) Inventors: Michael T. Kotschenreuther, Austin, TX (US); Swadesh M. Mahajan, Austin, TX (US); Prashant M. Valanju, Austin, TX (US)

Correspondence Address: Ballard Spahr LLP, SUITE 1000, 999 PEACHTREE STREET, ATLANTA, GA, 30309-3915, US

(21) Appl. No.: 12/502,525

(22) Filed: Jul. 14, 2009

(51) Int. Cl. G21G 1/06

(52) U.S. Cl. 376/158

(57) ABSTRACT

Disclosed herein are embodiments of systems and methods for creating radioisotopes. In one aspect, a Compact Fusion Neutron Source (CFNS) as described herein, can be used to create radioisotopes. The generation of the radioisotopes can utilize (n,2n), (n,p), (n,d), or (n,α) reactions, which can be caused by the high energy neutrons created by fusion. This abstract is intended for use as a scanning tool only and is not intended to be limiting.

### ACKNOWLEDGEMENT

This invention was made with U.S. government support under Grant Nos. DE-FG02-04ER54742 and DE-FG02-04ER54754 awarded by the United States Department of Energy. The U.S. government has certain rights in the invention.

### BACKGROUND

Isotopes, and in particular radioactive isotopes or radioisotopes can be very useful in for example industrial, medical and military applications. However, while some radioisotopes are naturally occurring, they may be found in only limited amounts and may be difficult to separate from other materials. Therefore, most radioisotopes are produced artificially.

At present there are up to 200 radioisotopes used on a regular basis, most produced artificially. Currently, radioisotopes can be manufactured in several ways. The most common is by neutron activation in a nuclear reactor. This involves the capture of a (thermal) neutron by the nucleus of an atom resulting in an excess of neutrons (neutron rich). Some radioisotopes are manufactured in a cyclotron in which protons are introduced to the nucleus resulting in a deficiency of neutrons (proton rich).

Radioisotopes have very useful properties: radioactive emissions are easily detected and can be tracked until they disappear leaving no trace. Alpha, beta and gamma radiation, produced by decaying radioisotopes, like x-rays, can penetrate seemingly solid objects, but are gradually absorbed by them. The extent of penetration depends upon several factors including the energy of the radiation, the mass of the particle and the density of the solid. These properties lead to many applications for radioisotopes in the scientific, medical, military, forensic and industrial fields.

Useful radioisotopes include, for example, U-235 (used for nuclear weapons) and Iodine-131 (used for medical tracing). Examples of other useful radioisotopes include Americium-241 (used in backscatter gauges, smoke detectors, fill height detectors and in measuring ash content of coal); Caesium-137 (used for radiotracer technique for identification of sources of soil erosion and deposition, in density and fill height level switches); Silver-110m, Cobalt-60, Lanthanum-140, Scandium-46, and Gold-198 (used together in blast furnaces to determine resident times and to quantify yields to measure the furnace performance); Cobalt-60 (used for gamma sterilisation, industrial radiography, density and fill height switches); Gold-198 & Technetium-99m (used to study sewage and liquid waste movements, as well as tracing factory waste causing ocean pollution, and to trace sand movement in river beds and ocean floors); Strontium-90, Krypton-85, and Thallium-204 (used for industrial gauging); Zinc-65 and Manganese-54 (used to predict the behaviour of heavy metal components in effluents from mining waste water); Iridium-192, Gold-198 and Chromium-57 (used to label sand to study coastal erosion); Ytterbium-169, Iridium-192 and Selenium-75 (used in gamma radiography and non-destructive testing); Technetium-99m, Phosphorus-32 and Indium-111, used in medical diagnostic procedures; Ni63, used in atomic batteries and smoke detectors and as a substitute for tritium in some applications; and Tritiated Water (used as a tracer to study sewage and liquid wastes); among others.

However, current methods of radioisotope production can be expensive, time-consuming, and inefficient. In addition, in some cases, it is difficult to obtain isotopes with the required activity level, since they may be contaminated by non-radioactive isotopes of the same elements.

Therefore, there remains a need for systems and methods of producing radioisotopes so as to effectively overcome challenges in the current art, some of which are mentioned above.

### SUMMARY

Disclosed herein are embodiments of systems and methods for producing radioisotopes. In one aspect, a Compact Fusion Neutron Source (CFNS) as described herein, can be used to create radioisotopes, though other methods of creating isotopes are contemplated. The generation of some radioisotopes require reactions with high energy neutrons, such as (n,2n) reactions, (n,p) reactions, (n,α), and (n,d) reactions. High energy neutrons created by fusion are very efficient at causing these reactions. Also, daughters of radioisotopes produced by such reactions as (n,2n), (n,p) and (n,α) can also be useful. Potential radioisotopes include for example U232, Th228 and Pu236, P32, Ni63, In111 although other radioisotopes are contemplated.

In one aspect, neutrons from fusion of Deuterium and Tritium (DT) are used to create radioisotopes.

Additional advantages will be set forth in part in the description which follows, and in part will be obvious from the description, or may be learned by practice. Other advantages will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, not necessarily drawn to scale, which are incorporated in and constitute a part of this specification, illustrate several embodiments and together with the description serve to explain the principles of the invention, and in which:

FIG. 1 shows a cross-sectional view of a disclosed embodiment of a reactor;

FIG. 2 shows a three dimensional views of the disclosed embodiment shown in FIG. 1;

FIG. 3 shows a cross-sectional view of a disclosed embodiment generated by CORSICA™;

FIG. 4 shows a vessel around a central axis;

FIGS. 5A-5B show flow charts for methods for embodiments of methods for creating and using radioisotopes;

FIG. 6 shows a prior art magnetic confinement configuration comprising a limiter and a diverter;

FIG. 7 shows a prior art magnetic confinement configuration comprising an X diverter, as described in Kotschenreuther et al. “On heat loading, novel diverters, and fusion reactors,” Phys. Plasmas 14, 72502/1-25 (2006);

FIG. 8 shows a modified schematic of a tokamak comprising an embodiment of a disclosed diverter;

FIG. 9A shows an upper region of CORSICA™ equilibrium for an exemplary embodiment;

FIG. 9B shows an upper region of CORSICA™ equilibrium for an exemplary embodiment, wherein the diverter coil is split into two distinct diverter coils;

FIG. 9C shows an upper region of CORSICA™ equilibrium for an exemplary embodiment, wherein the diverter coil is split into four distinct diverter coils;

FIG. 10 shows an exemplary diagram of a Fusion Development Facility (FDF) based embodiment for a disclosed FDF based reactor;

FIG. 11 shows an upper region of CORSICA™ equilibrium for an exemplary embodiment for a Component Test Facility (CTF) with Cu coils;

FIG. 12 shows an upper region of CORSICA™ equilibrium for an exemplary embodiment for a Slim-CS, a reduced size central solenoid (CS) based reactor with superconducting coils;

FIG. 13 shows upper region of CORSICA™ equilibrium for an exemplary embodiment for an ARIES (Advanced Reactor Innovation and Evaluation Study) based reactor (using modular coils that fit inside the extractable sections bounded by the dotted line);

FIGS. 14A & 14B shows (a) a diagram of National High-power Advanced Torus Experiment (NHTX) based embodiment and (b) CORSICA™ equilibrium for a disclosed NHTX based reactor;

FIG. 15A shows a standard NHTX configuration (prior art);

FIG. 15B shows a SOLPS (Scrape-off Layer Plasma Simulation) calculation for an NHTX based reactor comprising an embodiment of a disclosed diverter configuration;

FIG. 15C shows upper region of CORSICA™ equilibrium for a disclosed NHTX based embodiment;

FIG. 16 shows a cross-section plot of ITER (International Thermonuclear Experimental Reactor) plasma size compared to high power density plasma sizes achievable using embodiments described herein; and

FIG. 17 is a plot showing the reduced effect of plasma motion on location of diverter strike-point for a disclosed diverter as compared to the greater effect of the same plasma motion on plasma X point.

### DETAILED DESCRIPTION

The devices, systems and methods described herein may be understood more readily by reference to the following detailed description and the examples included therein and to the figures and their previous and following description.

Before the present systems, articles, devices, and/or methods are disclosed and described, it is to be understood that this invention is not limited to specific systems, specific devices, or to particular methodology, as such may, of course, vary. It is also to be understood that the terminology used herein is for the purpose of describing particular embodiments only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the embodiments of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Although any methods and materials similar or equivalent to those described herein can be used in the practice or testing of the present invention, example methods and materials are now described.

Throughout this application, various publications are referenced. Unless otherwise noted, the disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which may need to be independently confirmed.

As used in the specification and the appended claims, the singular forms “a,” “an” and “the” include plural referents unless the context clearly dictates otherwise. Thus, for example, reference to “a diverter plate,” “a reactor,” or “a particle” includes combinations of two or more such diverter plates, reactors, or particles, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “optional” or “optionally” means that the subsequently described aspect may or may be present or that the subsequently described event or circumstance may or may not occur, and that the description includes instances where said event or circumstance occurs and instances where it does not. For example, a disclosed embodiment can optionally comprise a fusion plasma, i.e., a fusion plasma can or cannot be present.

“Exemplary,” where used herein, means “an example of” and is not intended to convey a preferred or ideal embodiment. Further, the phrase “such as” as used herein is not intended to be restrictive in any sense, but is merely explanatory and is used to indicate that the recited items are just examples of what is covered by that provision.

Disclosed are the components to be used to prepare the compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of components A, B, and C are disclosed as well as a class of components D, E, and F and an example of a combination component, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions. Thus, if there are a variety of additional steps that can be performed it is understood that each of these additional steps can be performed with any specific embodiment or combination of embodiments of the methods.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### BACKGROUND

Described herein are systems and methods of creating radioisotopes that can be used for numerous applications, including but not limited to medical and military applications. In one aspect, the radioisotopes can be created using the high power density of CFNS, though other methods of creation are contemplated.

Radioisotopes can be created by reactions with high-energy neutrons such as (n,2n) reactions, (n,p) reactions, (n,α), and (n,d) reactions. Neutrons which are generated by, for example, deuterium-tritium (DT) fusion reactions are well above the energy threshold for (n,2n) reactions. Only a very small fraction (a few percent) of neutrons from other large-scale sources of neutrons (e.g., fission or nuclear spallation in which a nucleus, after being hit by a high energy nuclear particle, breaks into many fragments including neutrons.) exceed this threshold. Hence, a DT fusion neutron source is efficient at causing (n,2n) reactions

In one aspect, DT neutrons are used because the generation of radioisotopes require high energy neutrons to cause the reactions, Such reactions include (n,2n), (n,p), (n,α), and (n,d) reactions. Fusion neutrons are much more efficient at causing these reactions than other neutron sources because they have higher energy. Potential trace radioisotopes that can be created include for example U232, Th228 Pu236, P32, Ni63, and In111 among others. Exemplary reaction sequences to generate the particular isotopes above are:
For U232: Th232+n=>Th231+2n
   Th231=>Pa231 (half life 25 hr)
   Pa231+n=>Pa 232
   Pa 232=>U232 (half life 1.3 days)
For Th228: Th228 is a decay product of U232, so start by making U232 as above
   U232=>Th228 (half life 74 yr)
For Pu236: Np237+n=>Np236+2n
   Np236=>Pu236 (half life 22 hrs)
For P32: S32+n=>P32+p
For Ni63: Cu63+n=>Ni63+p
For In111: Sn112+n=>Sn 111+2n
   Sn 111=>In111 (half life 35 minutes)

In each of the above exemplary processes, the first step in each process above uses the DT neutrons. Other useful radioisotopes that can be created using embodiments described herein include Americium-241; Caesium-137; Silver-110m; Cobalt-60; Lanthanum-140; Scandium-46; Gold-198; Technetium-99m; Strontium-90; Krypton-85; Thallium-204; Zinc-65; Manganese-54; Iridium-192; Chromium-57; Ytterbium-169; Selenium-75; Phosphorus-32; Nickel-63; Indium-111; Tritium; and Tritiated Water, among others.

In one aspect, radioisotopes can be created by an embodiment of a CFNS, as described herein,

Radioisotopes created by embodiments of systems and methods described herein have many useful functions including for example radioactive emissions are easily detected and can be tracked until they disappear leaving no trace; alpha, beta and gamma radiation, produced by decaying radioisotopes, like x-rays, can penetrate seemingly solid objects, but are gradually absorbed by them; nuclear weapons; medical diagnosis, medical therapy, and medical tracing; backscatter gauges; smoke detectors; atomic batteries; radioisotope electricity generators; fill height detectors; measuring ash content of coal; radiotracer technique for identification of sources of soil erosion and deposition; density and fill height level switches; measure the furnace performance of blast furnaces; gamma sterilization; industrial radiography; sewage and liquid waste movements; tracing factory waste; trace sand movement; industrial gauging; predict the behavior of heavy metal components in effluents from mining waste water; gamma radiography and non-destructive testing, among others.

### Compact Fusion Neutron Source (CFNS)

Nuclear fusion is a source of neutrons and energy derived from nuclear combinations of light elements into heavier elements resulting in a release of energy. In fusion, two light nuclei (such as deuterium and tritium) combine into one new nucleus (such as helium) and release enormous energy and other particles (such as a neutron in the case of the fusion of deuterium and tritium) in the process. Nuclear fusion is more neutron-rich energy source than fission, i.e., more neutrons are produced per unit of energy released in fusion as compared to fission. While fusion is a spectacularly successful energy source for the sun and the stars, the practicalities of harnessing fusion on Earth are technically challenging, given that to sustain fusion, a plasma (a gas consisting of charged ions and electrons), or an ionized gas, has to be confined and heated to millions of degrees Celsius in a fusion reactor for a sufficient period of time to enable the fusion reaction to occur. The science behind fusion is well advanced, rooted in more than 100 years of nuclear physics and electromagnetic and kinetic theory, yet current engineering constraints make the practical use of nuclear fusion as a direct energy source very challenging. One approach to fusion reactors uses a powerful magnetic field to confine plasma so that it can be heated to high temperatures, thereby releasing fusion energy in a controlled manner. To date, the most successful approach for achieving controlled fusion is in a donut-shape or toroidal-shape magnetic configuration called a tokamak. While a tokamak can, in principle, be used as a source of the fast neutrons needed for creating radioisotopes, the current art of fusion reactors limits tokamaks to power densities that are far too low (by factors of 5 or more) for this purpose to be economic.

With current tokomak technology, the confinement of plasma to produce nuclear fusion reactions can be accomplished with a magnetic field (i.e., a magnetic bottle) created inside a vacuum chamber of a fusion reactor. Since the plasma is ionized, plasma particles tend to gyrate in small orbits around magnetic field lines, i.e., they essentially stick to the magnetic field lines, while flowing quite freely along the field lines. This can be used to “suspend” bulk plasma in the vacuum chamber by using a properly designed magnetic field configuration, which is sometimes called a magnetic bottle. The plasma can be magnetically contained within the chamber by creating a set of nested toroidal magnetic surfaces by driving an electric current in the plasma, and by the placement of current-carrying coils or conductors adjacent to the plasma. Since magnetic field lines on these magnetic surfaces do not touch any material objects such as walls of the vacuum chamber, the very hot plasma can ideally remain suspended in the magnetic bottle, i.e., in the volume containing closed magnetic surfaces, for a long time, without the particles coming into contact with the walls. However, in reality, particles and energy very slowly escape magnetic confinement in a direction perpendicular to the magnetic surfaces as a result of particle collisions with one another or turbulence in the plasma. Decreasing this slow plasma loss, so that the particles and energy of the plasma are better confined, has been a fundamental focus of plasma confinement research.

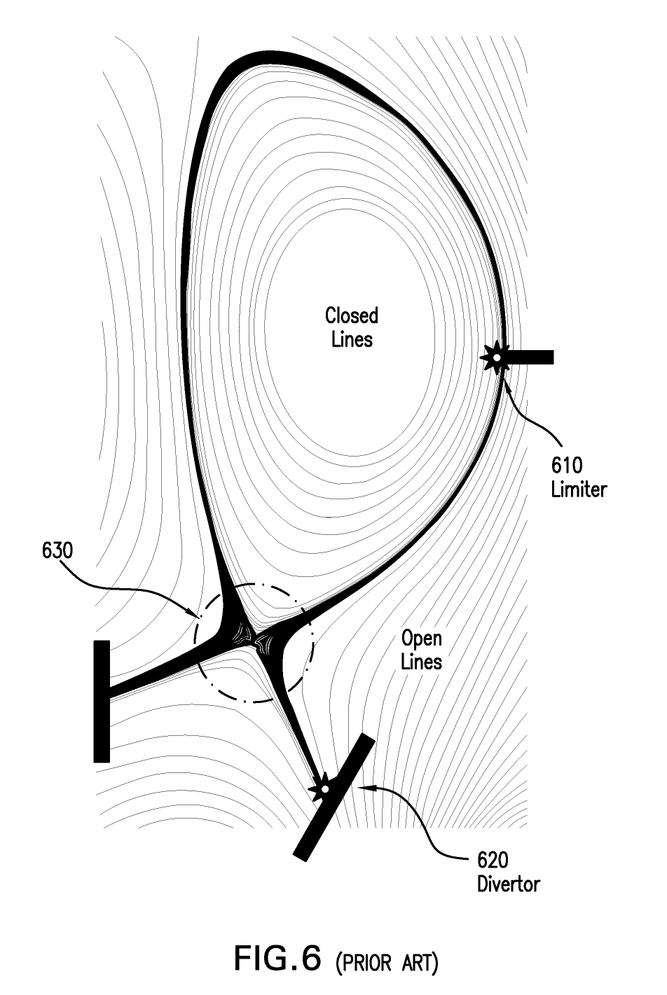

The boundary of the magnetic bottle containing closed magnetic surfaces, i.e., the “core plasma”, is defined by either material objects called limiters (e.g., 610 with reference to FIG. 6), or by a toroidal magnetic surface called a separatrix (e.g., 630 with reference to FIG. 6), outside of which the magnetic field lines are “open”, i.e., they terminate on material objects called diverter targets (e.g., 620 with reference to FIG. 6). The particles and energy slowly escaping the core plasma mainly fall on small areas of either limiter or diverter targets and generate impurities. Since limiters are right at the plasma boundary, while diverter targets can be placed farther away, core plasma can be better isolated from such impurities by using diverters. Since the invention of diverters, the preferred mode of plasma operation has been to have a separatrix and a diverter, since such operation has been found to enable a mode of operation called the H-mode, where the plasma particles and energy in the core are better confined.

Since particles flow very fast along magnetic lines but very slow across them, any particles and energy that escape across the separatrix reach diverter targets quickly along open field lines before moving much across them. This creates a necessarily narrow “scrape-off layer” with a high “scrape off flux” of particles and energy that falls on narrow areas of the diverter plates. The maximum “scrape off flux” that a diverter can handle limits the highest power density that can be sustained in a magnetic bottle.

High “scrape off flux” creates a multitude of challenges. In addition to heat and particle fluxes, the diverter plates also have to withstand large fluxes of neutrons created in fusion. These neutrons cause a degradation of many important material properties, making it extremely difficult for a diverter plate to handle both the high heat fluxes and neutron fluxes without having to be replaced frequently. Periodically replacing the damaged components is very time consuming and requires the fusion reaction to be shut off. Further, trying to reduce the “scrape off flux” by injecting impurities to radiate energy before it reaches diverter plates is not workable because the density of power coming out of the plasma becomes so high that it seriously degrades the plasma confinement, which results in a serious reduction of the fusion reaction rate in the core plasma.

To lower neutron and heat fluxes on a diverter and thus mitigate the damage to a diverter component, a reactor could simply be made larger to decrease the density of power within a device. However, this approach significantly increases the reactor cost, and hence the cost of any energy produced with it, to levels that are economically non-competitive with other methods for the generation of power or neutrons.

A high level of “scrape off flux” is a roadblock for many fusion applications, including nuclear fuel breeding. For example, for fusion reactors of sizes that can make them economically competitive with other methods of energy production, the high “scrape off flux” is intolerable for diverter designs based on current art. One way of handling challenges presented by high scrape off flux and enabling compact high-power density fusion neutron sources is described in U.S. patent application Ser. No. 12/197,736 to Kotschenreuther, et al, filed Aug. 25, 2008, fully incorporated herein by reference and made a part hereof.

As described herein, in one embodiment CFNS can be used as a source of neutrons for creation of the radioisotopes. In addition, a CFNS is an effective source of neutrons, as described herein. In one embodiment of a CFNS as described herein, the CFNS uses the Super X diverter to have a high power density.

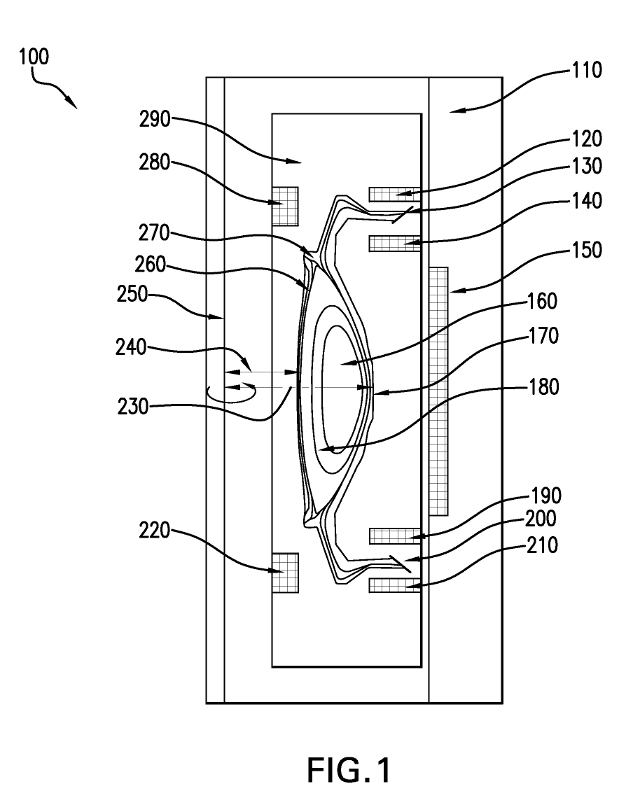

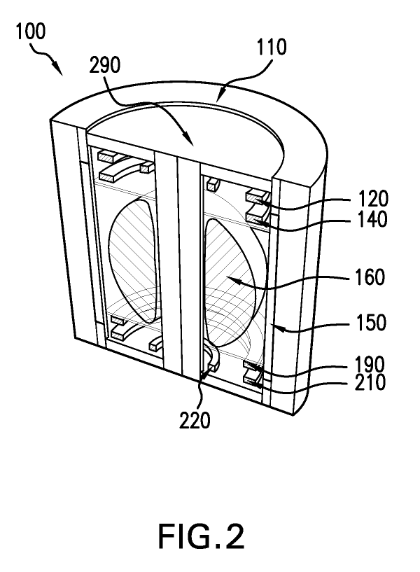

As an example, a disclosed embodiment can have a general configuration as shown in FIG. 1 and FIG. 2, which is a cross-sectional and perspective view of one half of a disclosed reactor 100. As shown in FIG. 1, a disclosed embodiment can comprise a first chamber substantially enclosed by walls 170 about a central axis 250. The chamber walls have an inner radius 240 that is closest to the central axis 250 and an outer radius 230 that is farthest from the central axis 250. The first chamber can optionally comprise a high power density neutron source (e.g., a core plasma) 160 that, when present, can be contained within said first chamber by closed magnetic surfaces 180 and open magnetic field lines 260 relative to the core plasma. The core plasma can produce fast (about 14 million electron volts) neutrons via fusion reactions, which, since uncharged, can travel away from the core plasma on a given trajectory. The neutrons, when present, can bombard material 150 present in a second chamber substantially adjacent to at least a portion of the first chamber walls 170. In one aspect the material can be used to create radioisotopes such as the ones previously described herein. Optionally, to insulate the reactor from neutrons, portions of the reactor can comprise Pb sections 290. In addition, a Pb sheath 110 can substantially surround the material in the second chamber 150. The open 260 and closed 180 magnetic field lines can be created by a current induced by current-carrying conductors, including, without limitation, toroidal field (TF) coils 280 and 220 as well as poloidal field (PF) coils 120, 140, 190, and 210. A main boundary or separatrix 270 can exist between open 260 and closed 180 magnetic field lines, i.e., the boundary between opened and closed magnetic drift trajectory. Particles, heat, and/or energy that cross the closed magnetic surfaces 180 (i.e., cross-field flux) can be directed to one or more diverter plates 130 and 200 by the open magnetic field lines 260.

In one aspect, a high power density neutron source can be a core plasma or fusion plasma that emits neutrons from the plasma such that the material absorbs said neutrons and converts, at least partially, into a radioisotope material.

In a further aspect, a plasma substantially confined within the first chamber can have a total heating power, i.e., heating power from all sources including both external and thermonuclear, such that the total heating power divided by the plasma major radius is 30 megawatts per meter per second or higher. In a still further aspect, a substantially confined plasma can produce an averaged total neutron power equal to about 0.1 megawatts per meter squared per second or higher, crossing the surface of the plasma. By “averaged total neutron power,” it is meant that the neutron power of a reactor can be averaged over a period of time to provide an averaged power. For example, a disclosed total neutron power can, in one aspect, refer to the total neutron power averaged over a one year period. In other aspects, the averaged period can be less than one year.

The term “material” as used herein is used to describe anything from which useful radioisotopes can be made with (n,2n), (n,p), (n,d), or (n,α) reactions or daughters of said reactive products.

Thus, in one aspect, the second chamber can comprise a material, such as the materials discussed above. If a breeding reaction has occurred, the second chamber can further comprise a radioisotope (i.e., the product of the material upon neutron capture). The radioisotope can be a material discussed above, or an otherwise radioisotope material.

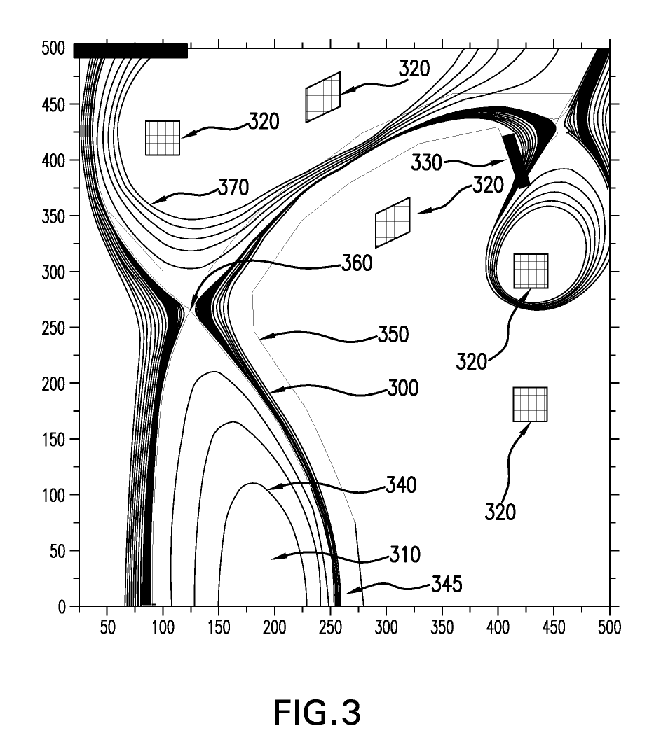

The source of high power density neutrons can have a magnetic geometry and coil and diverter configuration, for example, as shown in FIG. 3, which is a cross-sectional view of a section of a toroidal reactor generated by a CORSICA™ computer program. CORSICA™ is software developed by The Lawrence Livermore National Laboratory, Livermore, Calif., for simulating physics processes in a magnetic fusion reactor. In this embodiment, plasma 310 can be primarily confined by closed magnetic surfaces 340, wherein a scrape off layer (SOL) 300 exists beyond said closed magnetic surfaces. The closed magnetic surfaces 340 (i.e., the toroidal field) about the plasma 310 are caused by a current induced in the plasma 310 by a toroidal field (TF) coil or conductor (not shown) that goes substantially through the center of the toroid, thereby inducing the current in the plasma 310 by a transformer action, as known in the art. The SOL 300 can comprise open magnetic field lines (relative to the closed magnetic surfaces 340 of the fusion plasma). A vacuum chamber 345 can be substantially enclosed by walls 350. Additional magnetic field lines 370 can exist outside said vacuum chamber. Coils 320 or current carrying conductors in or adjacent to the walls 350 can be used to produce magnetic fields (i.e., poloidal fields (PF)) that cause the open magnetic field lines. Said coils 320 or current-carrying conductors can shape and/or control magnetic field lines if there is a need to shape and/or control said lines, and create the open magnetic field lines for diverting cross-field flux (or scrape-off flux), i.e., particles that migrate from the fusion plasma 310 across the closed field lines 340 to the open magnetic field lines. Scrape-off flux can be diverted by the open magnetic field lines to a diverter plate 330, which as shown in FIG. 3 and can optionally be shielded from neutrons emitted from the fusion plasma 310. Because the diverter plate 330 is at a radial distance (straight line distance) from the fusion plasma 310 and at a magnetic distance (distance along a magnetic field line from the fusion plasma to the diverter plate) that is greater than other fusion reactors found in the art, the open magnetic field lines can be spread further at the diverter plate, thereby mitigating heat concentration on the diverter plate 330, and allowing radiant cooling of the particle from the time it leaves the fusion until it arrives at the diverter plate 330. In this embodiment, a second chamber comprising material (not shown) can be substantially adjacent to at least a portion of said plasma 310 and/or said vacuum chamber 345 for confining said plasma. Various modifications of this embodiment can be made, as will be apparent from the present disclosure.

The reactor for creating radioisotopes can comprise any vessel compatible with fusion, and is not necessarily limited to known vessel designs. A vessel for containing plasma can be a fusion neutron source, if a reactive plasma is present. A vessel for containing plasma can also be a tokamak. It is understood that any disclosed component or embodiment can be used with any disclosed vessel for containing plasma, fusion plasma, fusion neutron source, or tokamak, or method of exhausting heat therefrom, unless the context clearly dictates otherwise.

In one aspect, the first chamber can be a toroidal chamber substantially enclosed by walls about a central axis, wherein said toroidal chamber has an inner radius and an outer radius relative to the central axis; a diverter plate for receiving exhaust heat from a fusion plasma substantially contained within the toroidal chamber by magnetic fields, said diverter plate having a diverter radius relative to the central axis and said diverter radius at least greater than or equal to the inner radius of the toroidal chamber. A second chamber comprising fertile material can be substantially adjacent to the fusion plasma.

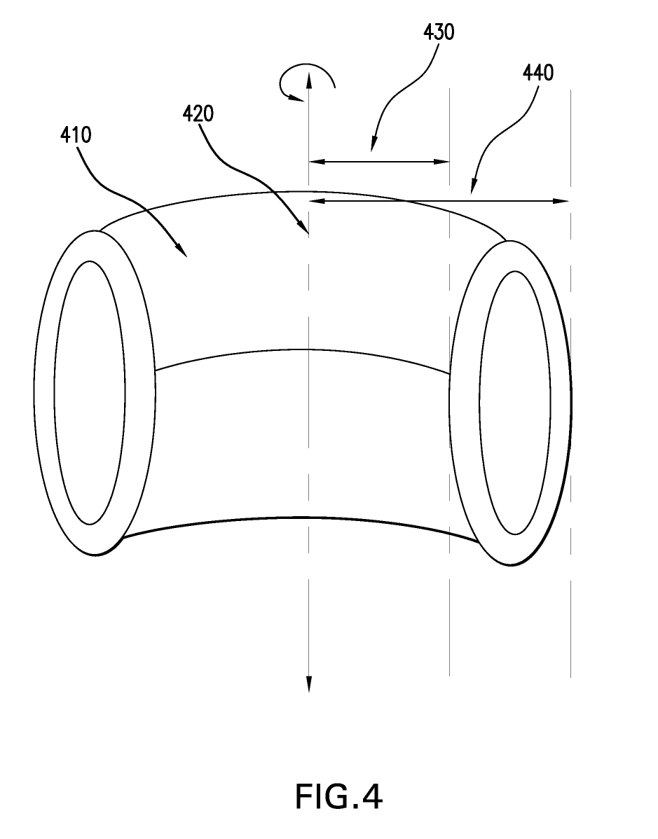

As used herein, “central axis” refers to an axis lying within a plane and passing through the centroid of a disclosed embodiment. A portion of a vessel, for example, surrounding a central axis is shown in FIG. 4. A portion of a vessel 410 surrounds a central axis 420. A point in space extending outward and substantially perpendicular to said central axis has a radius relative to said central axis. For example, said vessel can have an inner radius 430 closest to said central axis 420 and an outer radius 440 farthest from said central axis 420. In one aspect, said inner and said outer radius can be defined as a point extending from an imaginary line substantially perpendicular to said central axis 420 and positioned along the same x-y-z plane as the diameter of said vessel.

A disclosed first chamber can be any shape compatible for confining fusion plasma. In some aspects, at least a portion of the disclosed chamber can be toroidal. By “toroidal,” it is meant that a rotation around a point on a central axis would be a toroidal rotation. Thus, in one aspect, a disclosed chamber is not necessarily toroidal as a whole, but rather a point within or on said chamber can produce, when rotated around a central axis, a toroidal shape.

In one aspect, a disclosed vessel can comprise any material known to be compatible with fusion reactors. Non-limiting examples include metals (e.g., tungsten and steel), metal alloys, composites, including carbon composites, combinations thereof, and the like.

In a further aspect, a disclosed embodiment comprises an improved diverter. As used herein, the “diverter” is meant to refer to all aspects within an embodiment that divert heat, energy, and/or particles from the core plasma to a desired location away from the core plasma. Examples of aspects of a diverter include, but are not limited to, the scrape-off layer, open magnetic field lines containing scrape-off flux therein, one or more diverter plates (or diverter targets), and one or more separatrices.

In a still further aspect, said diverter plate can comprise any material suited for use with a fusion reactor. Known existing diverter compositions can be used, such as, for example, tungsten or tungsten composite on a Cu or carbon composite. Other materials that can used include steel alloys on a high thermal conductivity substrate.

In one aspect, a diverter plate can have a diverter radius relative to the central axis and said diverter radius can be located at a position relative to another component or point within a disclosed embodiment. As one skilled in the art will appreciate, the ratio of the diverter radius relative to other components, e.g., the plasma or the chamber wall, etc., is intended to encompass any appropriate individual radius, and thus any actual diverter radius disclosed is meant to be purely exemplary, and as such, non-limiting.

As used herein, and represented by R_{div}, the term “diverter radius” is meant to refer to the farthest radial distance of the diverter plate from the central axis.

In one aspect, a diverter plate can have a diverter radius greater than or equal to about the outer radius of the toroidal chamber. In a further aspect, a diverter plate can have a diverter radius less than or equal to about the outer radius of the toroidal chamber. In a still further aspect, a diverter plate can have a diverter radius greater than or equal to about the inner radius of the toroidal chamber.

In one aspect, the ratio of the diverter radius, R_{div}, to the outer radius of the toroidal chamber, R_{c}, can be from about 0.2 to about 10, or from about 0.5 to about 8, or from about 1 to about 6, or from about 1 to about 5, or from about 1 to about 3, or from about 1 to about 2, of from about 1 to about 1.5.

In general, it is contemplated that any sized embodiment can be used. But, for example, said diverter plate can have a radius of about 0.2 m, 0.5 m, 1 m, 1.5 m, 2 m, 3 m, 4 m, m, 6 m, 7 m, 8 m, 9 m, or about 10 m. In a further aspect, a diverter radius can be about 1.9 m, 3.3 m, 4 m, 7.3 m, or 7.5 m.

In one aspect, a diverter plate can have a diverter radius relative to an X point on a separatrix. As used herein, the term “separatrix” refers to the boundary between open and closed magnetic surfaces, and an X point refers to a point on the separatrix where the poloidal magnetic field is zero. In one aspect, multiple X points exist in a disclosed embodiment, and main plasma X point refers to an X point adjacent to the said core plasma. For example, referring back to FIG. 3, the main X point is shown as 360. The radius of a main X point generally depends on the configuration of the magnetic field lines. In one aspect, a diverter plate can have a major radius that is greater than or equal to the radius of the main X point.

In one aspect, the ratio of the diverter plate radius to the X point radius, R_{div}/R_{X} can be from about 1 to about 5, or from about 1 to about 4, or from about 1 to about 3.5, or from about 1.5 to about 3.5. For example, a disclosed diverter plate and a disclosed separatrix can have radii as listed in Table 1, along with the corresponding ratio.

TABLE 1
Examples of R_{div} and Rₓ

| R_{div} (m) | Rₓ(m) | R_{div}/Rₓ |
|---|---|---|
| 3.25 | 1.75 | 1.9 |
| 7.25 | 4.50 | 1.6 |
| 7.50 | 4.25 | 1.8 |
| 4.00 | 1.50 | 2.7 |
| 3.25 | 1.75 | 1.9 |
| 1.90 | 0.60 | 3.2 |
| 1.95 | 0.70 | 2.8 |
| 4.00 | 2.20 | 1.8 |

In yet a further aspect, a diverter plate can have a diverter radius relative to the major plasma radius, defined as the distance from said central axis to said plasma center. For example, the ratio of the diverter radius to the major plasma radius (R), R_{div}/R, can be from about 0.5 to about 10, or from about 1 to about 8, or from about 1 to about 6, or from about 1 to about 5, or from about 2 to about 5, including, for example, 0.5, 1, 2, 3, 4, 5, 6, 7, 8, 9, or 10. As a specific non-limiting example, if a plasma major radius is 1 m, and a diverter radius is 2 m, then R_{div}/R=2.

In one aspect, said diverter plate can be at least partially shielded from neutrons emitted from the core plasma. In a further aspect, said chamber walls at least partially shield the diverter plate from neutrons emitted from said core plasma, as shown, for example, in FIG. 3.

The neutron flux is defined as a measure of the intensity of neutron radiation in neutrons/cm²-sec. Neutron flux is the number of neutrons passing through 1 square centimeter of a given target in 1 second. Using embodiments of a diverter plate described herein, calculations show a decrease in neutron flux by a factor of over 10 as compared to other diverter plate designs.

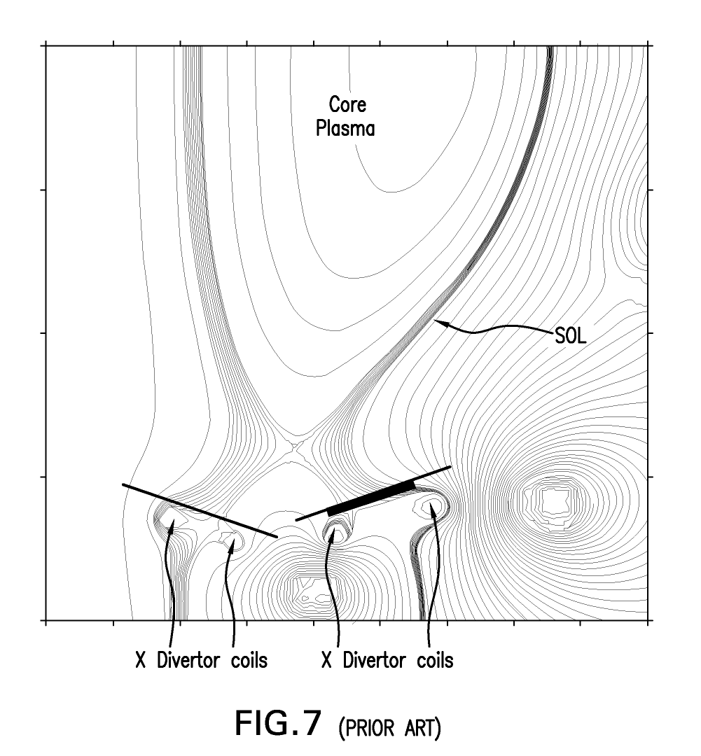

Additional diverter plates, not corresponding to the radii disclosed herein, can also be used in combination with a disclosed diverter plate. Specifically, known reactor designs can comprise diverter plates, wherein the diverter radius is less than the outer radius of a chamber, a plasma major radius, a separatrix, or another component or point within a vessel for containing fusion plasma. These known designs, in some aspects, can simply be augmented with an additional disclosed diverter design. Examples of such diverters include the standard diverter, as discussed herein, and the X diverter, as discussed in Kotschenreuther et al. “On heat loading, novel diverters, and fusion reactors,” Phys. Plasmas 14, 72502/1-25 (2006), which is hereby incorporated into this specification by reference in its entirety (hereinafter Kotschenreuther). An exemplary embodiment of an X diverter is shown in FIG. 7, wherein four poloidal field coils placed substantially adjacent to diverter plates expand the magnetic flux near the diverter plates so that the heat and plasma particle fluxes flowing from the core plasma into the SOL fall on larger areas of the diverter plates.

Referring to FIG. 3 and FIG. 4, in one aspect, a disclosed embodiment comprises a toroidal chamber 410 about a central axis 420. A major radius of any point denotes its perpendicular distance from the central axis 420. Directions perpendicular to the central axis 420 are radial, and directions in any plane containing the central axis 420 are poloidal. A toroidal core plasma 310 is substantially confined within the toroidal chamber 345 by closed magnetic surfaces 340 that stay substantially on closed toroidal magnetic surfaces. The toroidal core plasma 340 is substantially enclosed by a region of open magnetic field lines 300 that intersect one or more diverter plates 330 (this region can be referred to as the SOL (i.e., Scrape-Off Layer)). A magnetic surface known as a separatrix separates the core plasma and the SOL and intersects the diverter plates 330. Particles and energy that flow from the core plasma 340 across the separatrix into the SOL are directed along the open magnetic field lines 300 to the diverter plates 330. Both the closed magnetic surfaces 340 in the core plasma 310 and the open magnetic field lines 300 in the SOL are created by a current in the toroidal core plasma 310 and by currents in conductors 320 substantially adjacent to the toroidal chamber 345. The core plasma 310 and the SOL regions together are substantially enclosed by walls 350. An equatorial plane, which is perpendicular to the central axis 420, and which passes through a point at the largest major radius in the core plasma 340, divides the toroidal chamber 345 into upper and lower regions. When only the upper region is shown, as in FIGS. 3 and 4, the lower region is substantially a mirror image of the upper region in the equatorial plane. A major radius of any point is that point's perpendicular distance from the central axis. The major radii of points in the core plasma 340 that are farthest (or closest) from the central axis 420 are the outer plasma major radius (or inner plasma major radius). Half of the sum of the outer and inner plasma major radii is the plasma major radius, and half of the difference between the outer and inner plasma major radii is the plasma minor radius. A point in the upper (or the lower) region of the core plasma 340 farthest from the equatorial plane is the upper (or the lower) peak point. The largest major radius of points of intersection between the separatrix and the diverter plates 330 are the outboard diverter major radius and the corresponding diverter plate is the outboard diverter plate 330. A length along an open magnetic field line from a point approximately one-half centimeter outside the separatrix in the equatorial plane to the outboard diverter plate 330 is the SOL length, also known as the magnetic connection length.

A second chamber comprising material can be substantially adjacent to the core plasma 310, when present, and/or the toroidal chamber 410. An equatorial plane, which can be perpendicular to the central axis 420, and which passes through a point on the largest major radius line in the core plasma 310, divides the toroidal chamber 345 into upper and lower regions. The major radii of points in the core plasma 310 that are farthest (or closest) from the central axis 420 are the outer plasma major radius (or inner plasma major radius). Half of the sum of the outer and inner plasma major radii is the plasma major radius, and half of the difference between the outer and inner plasma major radii is the plasma minor radius. A point in the upper (or the lower) region of the core plasma 310 farthest from the equatorial plane is the upper (or the lower) peak point. The largest major radius of points of intersection between the separatrix and the diverter plates 330 are the outboard diverter major radius and the corresponding diverter plate is the outboard diverter plate 330. A length along an open magnetic field line from a point approximately one-half centimeter outside the separatrix in the equatorial plane to the outboard diverter plate 330 is the SOL length.

A stagnation point is defined as any point where a poloidal component of the magnetic field is zero. In one aspect, the separatrix contains at least one stagnation point whose perpendicular distance from the equatorial plane is greater than the plasma minor radius, and, for at least one diverter plate 330, the outboard diverter major radius is greater than or equal to the sum of the plasma minor radius and the major radius of the peak point closest to the corresponding diverter plate 330. In one aspect, this diverter plate 330 can be referred to as a Super-X Divertor or a Super X Divertor (SXD).

In one aspect, current-carrying conductors or coils substantially adjacent to the toroidal chamber expand a distance between said open magnetic field lines at the diverter plate relative to a distance between the open magnetic field lines at an outer radius of the toroidal chamber such that heat transferred to said diverter plate by said particles striking the diverter plate is distributed over an expanded area of the diverter plate. The current carrying conductors 320 substantially adjacent to the toroidal chamber 345 can create a magnetic flux expansion in the SOL, i.e., decrease the poloidal component of the magnetic field in the SOL. Therefore, energy and particles transferred to the diverter plate 330 can be distributed over an expanded area of the diverter plate 330, thus decreasing the average and peak fluxes of energy and particles incident on the diverter plate 330, and the SOL length can be optionally increased. In one aspect, the SOL length is greater than twice the SOL length for an instance in which the diverter plate is located at the corresponding stagnation point and in a plane perpendicular to the central axis. In a further aspect, the SOL length to the diverter plate is long enough so that electrons coming from the core plasma cool to a temperature of less than about 40 electron volts (eV) of energy before reaching said diverter plate.

In yet a further aspect, the low plasma temperature near the diverter plate 330 allows an increase in radiation of energy from the plasma near the diverter plate 330. In a still further aspect, the SOL lengths to the diverter plate 330 are long enough to maintain a detached plasma, i.e., maintain a stable zone of plasma at a temperature less than about 5 eV between the diverter plate 330 and the plasma.

In one aspect, the pumping ability (i.e., the pumping of helium ash from fusion reactions) can be enhanced by embodiments of the diverter plate as described herein because the major radius of the diverter plate is larger than the major radius of the nearest peak point by an amount greater than the plasma major radius. While not wishing to be bound by theory, this enhancement can result in a) an increase in the neutral pressure near the diverter plate, b) decreased pumping channel lengths from the diverter to pumps, and/or c) increased maximum area of the pumping ducts due to the larger major radius of a disclosed diverter.

Because of the larger major radius of embodiments of the diverter plates as described herein, a liquid metal such as, for example, lithium, can be present or flowing on a disclosed diverter, and can, in some aspect, be used efficiently on the diverter plates because the lower magnetic field at the larger major radius reduces the magnetohydrodynamic effects on the liquid metal.

In one aspect, the purity of the core plasma can be increased by embodiments of the diverter plate described herein. Without wishing to be bound by theory, this can result from a) a reduction in sputtering from the diverter plate due to lower plasma temperature, b) an increase in plasma density near the plate that can reduce the amount of sputtered material reaching the core plasma, and/or c) the increased length of a disclosed diverter as compared to standard diverters, which results in any sputtering occurring further from the core plasma and sputtering at the diverter plate can be shielded from the core plasma by the walls of the toroidal chamber or the longer SOL distance between the diverter plate and the core plasma.

It should be appreciated that in a further aspect, the longer line length of the SOL in the diverter can enable one or more of the following improvements as compared to devices with standard diverters: a) allowing lower plasma temperature near the diverter plates, b) allowing higher plasma and neutral densities near the diverter plates, c) enhanced spreading of heat by either plasma-generated or externally driven turbulence in the SOL, without also significantly increasing the turbulence in the core plasma, and/or d) sweeping the regions of highest heat or particle flux on the SXD plates at a rate fast enough so that the resulting spatial and temporal redistribution of the heat flux reduces the peak temperature of the diverter plate.

In one aspect, the use of embodiments of the diverter plate described herein allows power density in the core plasma to be substantially higher than known toroidal plasma devices. In a further aspect, the fusion power density in the core plasma is substantially higher than known toroidal-plasma devices. For example, if power density is defined as the quotient of the core heating power in megawatts and the plasma major radius (described in more detail herein) in meters, then embodiments described herein can produce a power density of about five megawatts per meter or greater. Of course, lower power densities are also contemplated within the scope of the described embodiments. This high power density can result in a core plasma of sufficient heat and density to produce a large number of neutrons from fusion reactions of plasma particles.

It will be apparent that the various disclosed radii for components within a disclosed embodiment can be determined by a physical measurement of a working embodiment. Or, in the alternative, a disclosed radius can be determined through a model, such as, for example, a model generated by CORSICA™. Thus, in one aspect, a physical embodiment can be deduced to a model, and the various parameters can be determined by the model.

In one aspect, a disclosed embodiment comprises plasma or fusion plasma that is substantially magnetically contained within a vessel for containing the plasma, a fusion neutron source, or a tokamak, by closed magnetic surfaces and open magnetic field lines relative to the fusion plasma. A disclosed core plasma can have a major radius and a minor radius. The major radius of the plasma can be the radius of the plasma as a whole (from the central axis to the center of the plasma). The minor radius can be the radius of the plasma itself, i.e., a distance extending from the center of the plasma to the perimeter of said plasma.

The fuel to be used as plasma can, at least in principle, comprise combinations of most of the nuclear isotopes near the lower end of the periodic table. Examples of such include, without limitation, boron, lithium, helium, and hydrogen, and isotopes thereof (e.g., ²H, or deuterium). Non-limiting reactions of deuterium and helium, for example, which can occur within nuclear fusion plasma are listed below.

D+D→p+T(tritium)+˜3 MeV, wherein p is a proton.

D+D→n+³He+˜4 MeV, wherein n is a neutron.

D+T→n+⁴He+˜17 MeV.

D+³He→p+⁴He+˜18 MeV.

Any known means of heating a fuel to create said fusion plasma, and heating said fusion plasma to the temperatures required for fusion to occur can be used in combination with the disclosed embodiments, including the disclosed methods. Plasmas can be generated in various ways including DC discharge, radio frequency (RF) discharge, microwave discharge, laser discharge, or combinations thereof, among others. Plasmas can be generated and heated, for example, by ohmic heating, wherein plasma is heated by passing an electrical current thought it. Another example is magnetic compression, whereby the plasma is either heated adiabatically by compressing it though an increase in the strength of the confining field, or it is shock heated by a rapidly rising magnetic field, or a combination thereof. Yet another example is neutral beam heating, wherein intense beams of energetic neutral atoms can be focused and directed at the plasma from neutral beam sources located outside the confinement region.

Combinations of the aforementioned heating protocols can be used, as well other methods of heating. For example, neutral beam heating can be used to augment ohmic heating in a magnetic confinement device, such as a tokamak. Other methods of heating include, without limitation, heating by RF, microwave, and laser.

Any appropriately shaped plasma of any size compatible with a disclosed embodiment can be used. A discussion of plasma shapes can be found in “ITER,” special issue of Nucl. Fusion 47 (2007), which is hereby incorporated by reference into this specification in its entirety. The shape of fusion plasma, in one aspect, can determine the desire of a particular shape of a vessel for containing said fusion plasma.

Various factors can determine a desired plasma size, one of which is the containment time, which is Δt=r²/D, wherein r is a minimum plasma dimension and D is a diffusion coefficient. The classical value of the diffusion coefficient is D_{c}=aᵢ²/τᵢₑ, wherein aᵢ is the ion gyroradius and τᵢₑ is the ion-electron collision time. Diffusion according to the classical diffusion coefficient is called classical transport.

The Bohm diffusion coefficient, attributed to short-wavelength instabilities, is D_{B}=(1/16)αᵢ²Ωᵢ wherein Qᵢ is the ion gyrofrequency. Diffusion according to this relationship is called anomalous transport. The Bohm diffusion coefficient for plasma, in some aspects, can determine how large plasma can be in a fusion reactors, vis-à-vis a desire that the containment time for a given amount of plasma be longer than the time for the plasma to have nuclear fusion reactions. On the contrary, reactor designs have been proffered wherein a classical transport phenomenon is, at least in theory, possible. Thus, in one aspect, one or more disclosed embodiments can be compatible with plasma comprising anomalous transport and/or classical transport.

During magnetic confinement of plasma, ionized particles can be constrained to remain within a defined region by specifically shaped magnetic fields. Such a confinement can be thought of as a nonmaterial furnace liner that can insulate hot plasma from the chamber walls.

In one embodiment, a magnetic field can be created to form a torus or a doughnut-shaped figure within which magnetic field lines form nested closed surfaces. Thus, in this geometry, plasma particles are permitted to stray only by crossing magnetic surfaces. In theory, this diffusion is a very slow process, the time for which has been predicted to vary as the square of the plasma minor radius, although much faster cross-diffusion patterns have been observed in experiment.

To direct anomalous and/or classical cross-magnetic field particle transport away from the plasma, particles from the fusion plasma that cross said separatrix can be directed to a plasma-wetted area on said diverter plate by said open magnetic field lines in said scrape off layer outside said separatrix.

In a further aspect, a disclosed embodiment can provide at least one diverter plate wherein the plasma-wetted area, A_{w}, on at least one diverter plate is increased beyond currently known fusion neutron source designs. Without wishing to be bound by theory, in an embodiment comprising one or more diverter plates, A_{w}, on the diverter plate can be bound via the equation Divergence of B=0, to be

$${A}_{w} = \frac{{B}_{p , sol}}{{B}_{div}} \frac{{A}_{sol}}{sin ( θ )} \approx {[ \frac{{B}_{p}}{{B}_{t}} ]}_{sol} \frac{{R}_{div}}{{R}_{sol}} \frac{{A}_{sol}}{sin ( θ )} ,$$

wherein Rₛₒₗ, Wₛₒₗ, and Aₛₒₗ=2πRₛₒₗWₛₒₗ are the radius, width, and area of the scrape-off layer (SOL) at the (outer or inner) midplane for the corresponding diverter plates, wherein θ is the angle between the diverter plate and the total magnetic field, B_{div}, and the subscripts p(t) denote the poloidal (toroidal) directions. For a given Wₛₒₗ and Bₚ/Bₜ at the midplane, A_{w} can be increased, in one aspect, by reducing θ. However, it is apparent that engineering constraints can, in some aspects, place a limit of about 1 degree on the minimum θ, as determined, for example, in the ITER design, outlined in “ITER,” special issue of Nucl. Fusion 47 (2007), which is hereby incorporated by reference into this specification in its entirety. However, some disclosed designs comprise a diverter plate with a θ of less than about 1 degree (e.g., 0.9°).

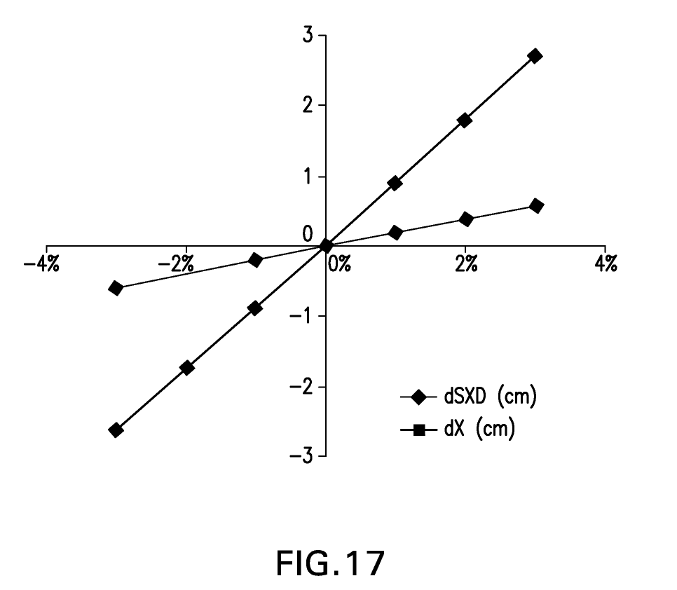

In one aspect, a disclosed embodiment can comprise an increase in R_{div}, the diverter radius (with respect to the central axis) to affect an increase in A_{w}. It should be appreciated that increasing R_{div}, in one aspect, increases the distance between the diverter plate and the current in the plasma, which can make the diverter less sensitive than a standard diverter to plasma fluctuations. For example, as shown in FIG. 17, by changing the plasma pressure (or current) by ±5% (while holding coil currents and flux through the wall fixed to simulate sudden changes), this moves the outer strike points on the disclosed diverter plate by only about ±0.05 cm (see curve labeled dSXD in FIG. 17) which is much smaller than about ±2.5 cm motion produced in a standard diverter (see curve labeled dX in FIG. 17), Such small motions are small fractions of the widths of an exemplary plasma-wetted area (about 20 cm).

In one aspect, particles from said fusion plasma can travel a magnetic distance along open magnetic field lines from the fusion plasma to the diverter plate that is greater than a radial distance from the fusion plasma to the diverter plate. In a further aspect, the particles cool while traveling the magnetic distance along the open magnetic field lines to the diverter plate.

It is apparent that an increase in R_{div}/Rₛₒₗ can increase the magnetic connection length, L, of a scrape off flux particle by increasing the poloidal field all along the diverter leg at R. In one aspect, an extended L can increase the maximum allowed power (Pₛₒₗ) in the scrape-off layer (SOL). The maximum diverter radiation fraction and the cross-field diffusion can both be enhanced. The longer L in a disclosed diverter can restore the capacity for substantial radiation even at high q_{II} (heat transferred per unit mass), increasing Pₛₒₗ relative to a standard diverter by a factor of about 2. The longer line lengths can lower the plasma temperature at the plate at relevant high upstream q_{II}. These results can be obtained, for example, by 1D-code, using CORSICA™, for example, as described in Kotschenreuther. As the plasma particles flow to the diverter along the extended field lines, cross-field diffusion effectively widens the SOL, resulting in a larger plasma footprint on the diverter plate. In one aspect, for example, an increase in SOL width by about 1.7 relative to a standard diverter can be expected.

A disclosed embodiment can provide for improvements in the capability of a fusion neutron source, vessel for containing fusion plasma, or tokamak to manage the problem of heat exhaust. The heat exhaust that occurs during the operation of a nuclear fusion reactor can be related to the heating power, Pₕ=auxiliary heating power, Pₐᵤₓ plus about 20% of the fusion power, P_{f}. For example, two of largest current tokamaks, the joint European torus (JET) in the European Union, with a major radius R=3 m, and the JT-60 tokamak in Japan, with R=3.4 m, each have a Pₕ<40 MW. ITER (France), a joint international research and development project that aims to demonstrate the scientific and technical feasibility of fusion power, by contrast, is designed for a Pₕ˜120 MW, with P_{f}˜400 MW. A measure of the severity of the heat flux problem can be estimated, in some aspects, as Pₕ/R, wherein R is the plasma major radius.

Kotschenreuther (previously incorporated by reference in its entirety), discusses the severity of the heat flux problem in detail. Specific reference is made to Table 1 of Kotschenreuther and the discussion of the data presented therein, as it applies to the present context, wherein various Pₕ/R values for known reactors, including future reactors, are listed.

In one aspect, a disclosed embodiment can be a tokamak. As used herein, the term “tokamak” refers to a magnetic device for confining plasma. While tokamaks generally comprise a toroidal shaped magnetic field which is substantially axisymmetric, i.e., approximately invariant under toroidal rotations about a central axis, a “tokamak,” as disclosed herein, is not limited to an axisymmetric toroidal shape. Other toroidal designs and shapes, both known and unknown, will likely be compatible with the various embodiments disclosed herein. Known toroidal alternatives to the traditional tokamak reactor are stellarators, spherical toroids (i.e., a cored apple shaped tokamak), reverse-field pinch reactors, and spheromaks.

In one aspect, a tokamak can further comprise a second chamber comprising a fertile material substantially adjacent to a chamber for confining core plasma. In addition, a sheath of neutron reflecting material (e.g., Pb) can substantially surround the tokamak, or at least the first chamber or the second chamber of the tokamak.

It should be appreciated that, in various embodiments, the geometrical configurations of the diverter plate as described herein can be accommodated by most, if not all, known tokamak designs, including predicted future tokamak designs. As an example, a diverter plate can fit inside toroidal field coils in corners or sections that often go unused, and any toroidal field ripple (unwanted curving of magnetic field lines) arising at the diverter plates can be handled by slight shaping of the magnetic field lines using, for example, an induced current.

In one aspect, a disclosed embodiment can be a Tokamak based High Power Density (HPD) Device. High power density of a disclosed device can be attained, for example, by reducing the size of the device, thereby increasing the power density. In one aspect, a disclosed high power density embodiment can have a major radius R of from about 0.2 m to about 5 m, or from about 0.2 m to about 4 m, or from about 0.2 m to about 3 m. Parameters for an exemplary high power density device are listed in Table 2. With reference to Table 1, an exemplary device can have a major radius of about 2.2 m, with an aspect ratio of about 2.5, wherein the aspect ratio is defined as the major/minor dimensions of the plasma torus at the horizontal equatorial plane (plasma major radius/plasma minor radius=aspect ratio).

As used herein, angular brackets such as < > denote average value of a parameter averaged over the core plasma volume. For example, <n> denotes the average density of particles in the core plasma.

Elongation of the plasma confined in a disclosed embodiment of a Tokamak based High Power Density (HPD) Device can be from about 1.5 to about 4, or from about 2 to about 3. Elongation measures the vertical height of the plasma minor cross section compared to the horizontal minor cross section. This parameter is typically measured at the separatrix (i.e., the magnetic surface dividing the closed plasma nested flux surfaces from the open ones that intersect the material walls) as well as at 95% of the flux at the separatrix (it can be zero at the plasma centre), which gives a good measure of the useful part of the plasma—the last 5% is affected somewhat by particles which are sometimes outside the separatrix and sometimes inside. With reference to Table 1, an exemplary high power density device can have an elongation of about 2.4 to about 2.7.

A disclosed embodiment of a Tokamak based High Power Density (HPD) Device can have a toroidal plasma current (Iₚ) of from about 1 to about 20 MA, or from about 1 to about 15 MA. It will be apparent that Iₚ can change during the operation of an embodiment. With reference to Table 2, for example, Iₚ for an exemplary embodiment can be from about 12 to about 14 MA. A disclosed HPD device can have a self-generated confinement magnetic field (bootstrap current fraction) of about 30 to about 90%, or from about 30 to about 80%. An exemplary device, for example, can have a bootstrap fraction of from about 40 to about 70% (Table 2). The current drive power in such a device, can be, for example, from about 20 to about 90 MW (e.g., from about 25 to about 60 MW, see Table 2). Although not wishing to be bound by theory, in one aspect, additional power for D-D fusion and/or Ion Cyclotron Resonance Heating (ICRH) can be from about 20 to about 50 MW. For example, power for these processes can be about 40 MW (Table 2).

If a Cu coil (e.g., a coil with about 60% Cu) is used for an HPD device, coil related dissipation can be about 160 MW for an exemplary device. The CD electric input to provide power to these coils can be, for example, from about 50 to about 120 MW. It is thought that the B_{T} at an exemplary Cu coil would be about 7 T (Table 2).

The I_{P} and other induced currents, if present, can create a magnetic flux density at the plasma center, B_{T}, of from about 2 T (Tesla) to about 10 T, or from about 2 T to about 5 T. For example, a disclosed HPD device can have a magnetic flux density at the plasma center of about 4.2 T (Table 2). The volume averaged temperature <T> can be from about 10 to about 20 keV, or from about 10 to about 18 keV. For example, an HPD device can have a volume averaged temperature <T> of about 15 keV (Table 2).

The normalized β (β_{N}) in a disclosed HPD device can be from about 2 to about 8, or from about 2 to about 5. An exemplary device, as listed in Table, can have a β_{N} of about 3-4.5. Normalized β (β_{N}), as used herein, is plasma beta times a·B/I (a=minor radius, B=toroidal magnetic field on central axis, and I=plasma current). Plasma beta is the ratio of plasma pressure (the sum of the product of density and temperature over all the plasma particles) divided by the magnetic pressure (B²/2μ₀)—a volume-integrated parameter which measures how good the magnetic field is at confining the plasma, and is typically a few % (percent).

Peaking value of a parameter is the ratio of its maximum value to its volume averaged value in the core plasma.

A disclosed HPD device can have a fusion power of up to 500 MW, or from about 0 MW to about 500 MW. An exemplary device, as listed in Table 2, can have a fusion power of up to about 400 MW, or from about 0 MW to about 400 MW. Fusion power, as used herein, is the total power generated by the fusion reactions in the plasma (i.e., not taking account of any energy multiplication that can take place by reactions in the surrounding structure). Other power parameters include Alpha-particle power, which is the part of the fusion power carried by the fused nuclei. Alpha power plus external heating power minus radiated power is the net heating power to the plasma. For a plasma generating a fusion power of up to 500 MW, an exemplary device can have a neutron wall load of from about 2 to about 3 MW/m² (Table 2). Impurities in the plasma, depending on the composition, can, in one aspect, comprise He (e.g., 10% He) and/or Ar (e.g., 0.25% Ar).

With reference to Table 2, a disclosed HPD device can have an H, wherein H is the energy confinement improvement factor compared with the ITER98h(y,2), of from about 1.3 to about 1 (for DIII-D reactions). It will be apparent that such a device can have a Q value, defined as the fusion power/input power of about 0.1 to about 1.7.

TABLE 2
Parameters for exemplary Tokamak High Power Density Device

| | |
|---|---|
| R major | 1.1 |
| Aspect ratio | 2.5 |
| Elongation | 2.7 |
| Iₚ | Up to 10MA |
| B_{T} (plasma center) | 4.1 T |
| <n> | 1.6 × 10²⁰ |
| <T> | 15 kev |
| β_{N} | 2-3 |
| Peaking p(0)/<p>, n(0)/<n> | 2.5, 1.6 |
| Fusion Power | Up to 50 MW |
| Bootstrap fraction | <50% |
| Current Drive power | 30 MW |
| H factor | 1-1.3 |
| Fusion Power | Up to 50 MW |
| Coil related dissipation | 70 MW |
| CD electric input | 60 MW |
| B_{T} at the TF coil | 7 T |
| Cu fraction in coil | 78% |
| Current Drive wall plug plasma efficiency | 50% |
| Neutron Wall load | Up to 1.1 MW/m² |

It is understood that the disclosed tokamaks can be used in combination with the disclosed components (e.g., diverter plates, etc.), methods, devices, and systems.

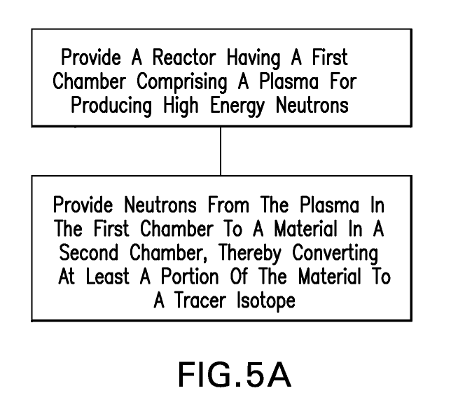

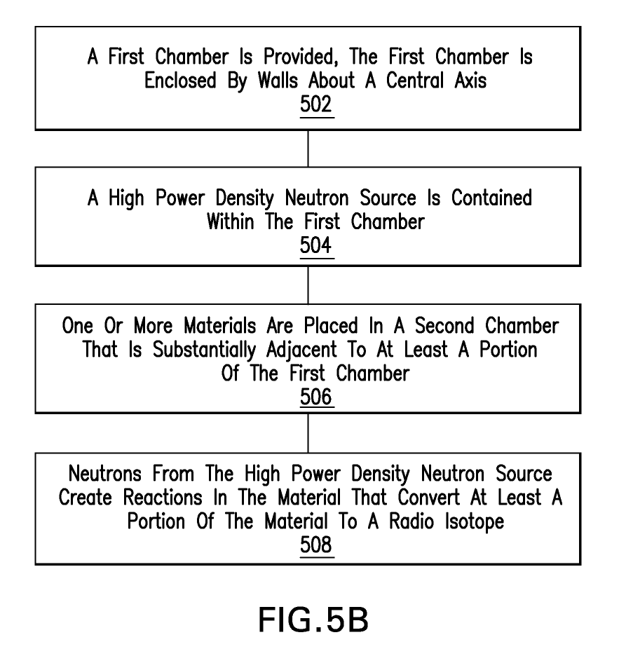

Also disclosed are methods of creating and using radioisotopes. In one aspect, as shown in the partial flowchart of FIG. 5A, a method of creating a radioisotope comprises the steps of: providing a reactor comprising a first chamber comprising a plasma for producing high power density neutrons, providing neutrons from the plasma in the first chamber to a material in a second chamber, thereby converting at least a portion of the material to a radioisotope.

The radioisotopes are created by (n,2n) reactions. Neutrons which are generated by, for example, deuterium-tritium (DT) fusion reactions are well above the energy threshold for (n,2n) reactions. Only a very small fraction (a few percent) of neutrons from other large-scale sources of neutrons (e.g., fission or spallation) exceed this threshold. Hence, a DT fusion neutron source is efficient at causing (n,2n) reactions.

FIG. 5B illustrates an embodiment of a method of creating a radioisotope. The described embodiment comprises step 502, providing a first chamber enclosed by walls about a central axis. At step 504, a high power density neutron source is contained within the first chamber. In one aspect, the high power density source is a compact fusion neutron source containing a core plasma and comprised of at least one diverter plate that has an outboard diverter major radius that is greater than a sum of a fusion plasma minor radius and a major radius of a peak point closest to the corresponding diverter plate. In one aspect, the compact fusion neutron source has a ratio of total heating power to a core plasma major radius of about 5 megawatts/meter or higher. Further, in one aspect the high power density neutron source is a tokamak with a core plasma major radius of about three meters or smaller. The high power density neutron source has a total power of about 0.1 megawatts per meter squared per second, or higher, of neutrons crossing a surface of the high power density neutron source. At step 506, a material is placed in a second chamber that is substantially adjacent to at least a portion of the first chamber. The material can be, for example, Th232, U232, or NP237, among other materials, Neutron-absorbing and neutron-reflecting materials can also placed in the second chamber so that at step 508 neutrons from the high power density neutron source convert at least a portion of the material to a radioisotope such as, for example, U232, Th22.8, or Pu236, among others.

One or more neutrons from said high power density neutron source can be absorbed by the material, creating an (n,2n) reaction resulting in a radioisotope.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. The examples provided herein describe a neutron source that can provide high-energy neutrons that can be used to create radioisotopes as described herein.

1. Modified Design of Steady State Superconducting Tokamak

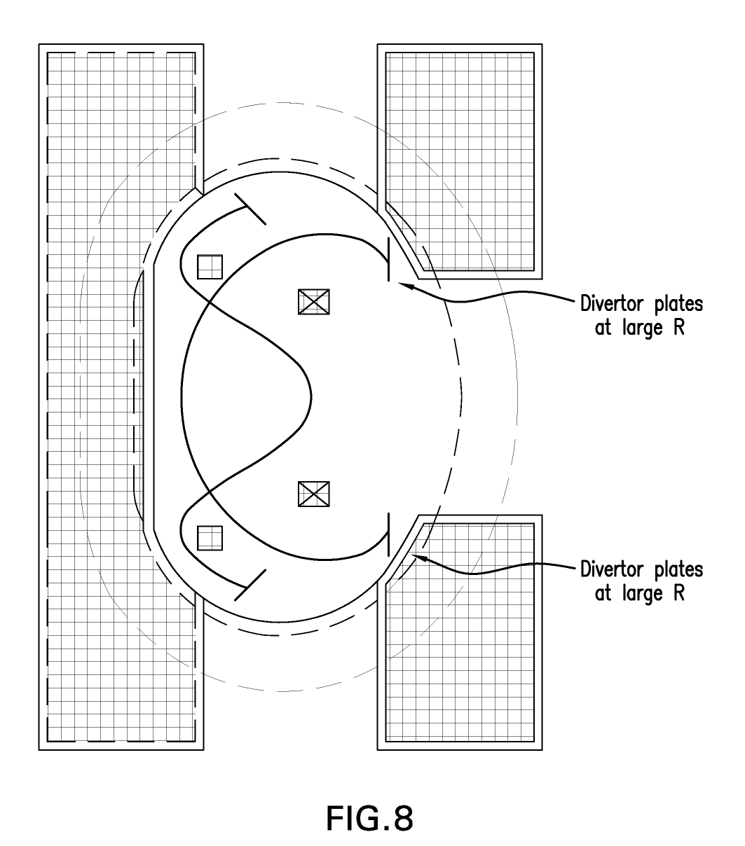

FIG. 8, modified from Bora et al., Brazilian Journal of Physics Vol. 32, no. 1, pg. 193-216, March 2002, the contents of which are incorporated herein by reference, displays an exemplary modified design of a Steady State Superconduction Tokamak (SST). Various parameters for the SST embodiment are listed in Table 3. An SST device can comprise a toroidal chamber, wherein at least a portion of the toroidal chamber comprises graphited-bolted tiles. Stabilizer materials can also be used with such a device and can comprise, for example, a Cu alloy (e.g., a Cu—Zr alloy). An exemplary SST design can have a plasma major radius, R, defined as the distance from the central axis to the center of the plasma, of about 1.1 m, and a plasma minor radius, a, defined as the distance from the center of the plasma to the perimeter of the plasma where the plasma is thickest, of about 0.2 m. The plasma current, Iₚ, as defined hereinabove, can be about 220 kA, with a Toroidal Field begin defined by a magnetic flux density at the plasma center, B_{T}, of about 3 Tesla. Such a device can comprise a fertile material substantially adjacent to the toroidal chamber.

The plasma for such an SST design can have an elongation of ≦ about 1.9, and a triangularity of ≦ about 0.8, wherein triangularity refers to a measure of the degree of distortion towards a D-shaped plasma minor cross section from an elliptic shaped plasma cross section. A fuel for a plasma confined within an SST device can, for example, comprise hydrogen gas. The plasma can be created and/or heated by ohmic heating, discussed hereinabove. Additional current that can be used during the course of an operation of an SST device include LHCD, or Lower Hybrid Current Drive, which can be current originating from quasi-static electric waves propagated in magnetically confined plasmas. The ohmic heating plus the LHCD can be, for example, 1 MW at 3.7 GHz. Ion Cyclotron Resonance Heating (ICRH) and Neutral Beam Injection Heating (NBI) can each be about 1 MW, wherein the sum of each is about 2 MW.

An exemplary SST device can have a diverter configuration as defined herein, wherein the diverter plate is positioned relative to a component or aspect of a device. A diverter configuration can be a double null (DN configuration). Such a diverter system can be compatible, for example, with an average heat load of about 0.5 MW/m², with a peak heat load of about 1 MW/m².

For a pulsed experiment, a discharge duration (i.e., the amount of time external current is applied to the device per pulse) can be, for example, about 1000 seconds.

TABLE 3
Parameters for modified SST design

| | |
|---|---|
| Major Radius, R | 1.1 m |
| Minor Radius, α | 0.2 m |
| Plasma Current Iₚ | 220 kA |
| Toroidal Field, B_{T} | 3 Tesla |
| Elongation | ≦1.9 |
| Triangularity | ≦0.8 |
| Discharge duration | 1000 seconds |
| Fuel Gas | Hydrogen |
| Divertor Configuration | DN |
| Divertor Heat Load | 0.5 MW/m² (average); 1 MW/m² (peak) |
| First Wall Material | Graphited-bolted tiles |
| Stabilizer Material | Cu-Zr alloy |
| Number of SC TF Coils | 16 |
| Number of SC PF Coils | 9 |
| Number of SC PF Coils | 6 |
| Current Drive | Ohmic + LHCD (1 MW @ 3.7 GHz) |
| Heating | ICRH (1 MW) NBI (1 MW) = 2 MW |

2. Divertor Designs Comprising Extended Single and Split Divertor Coils

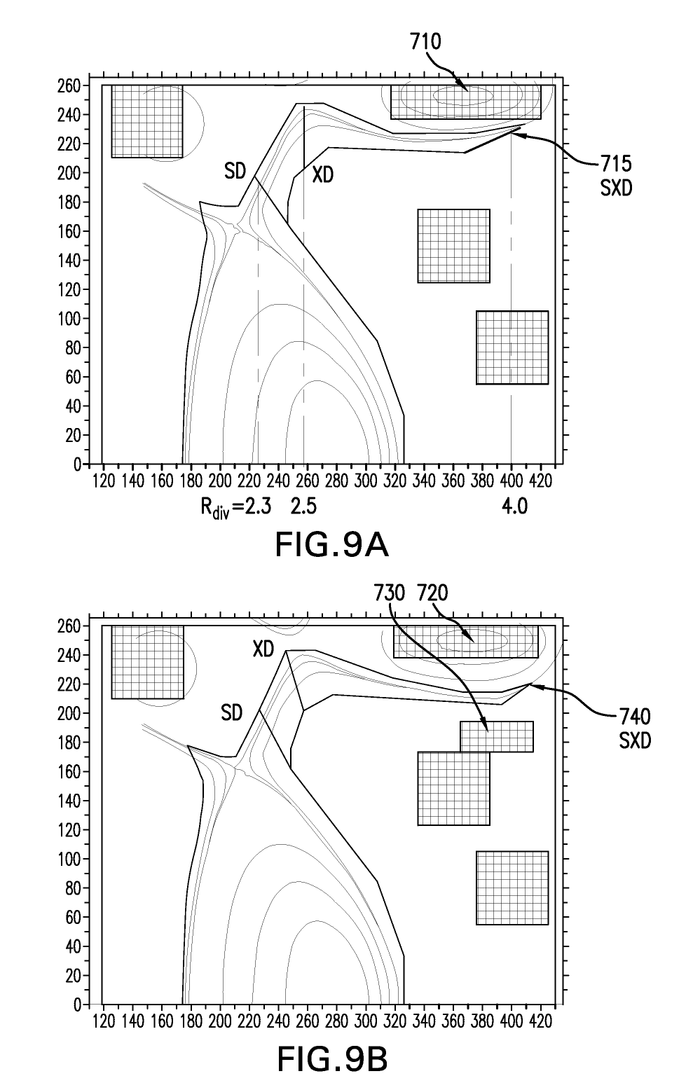

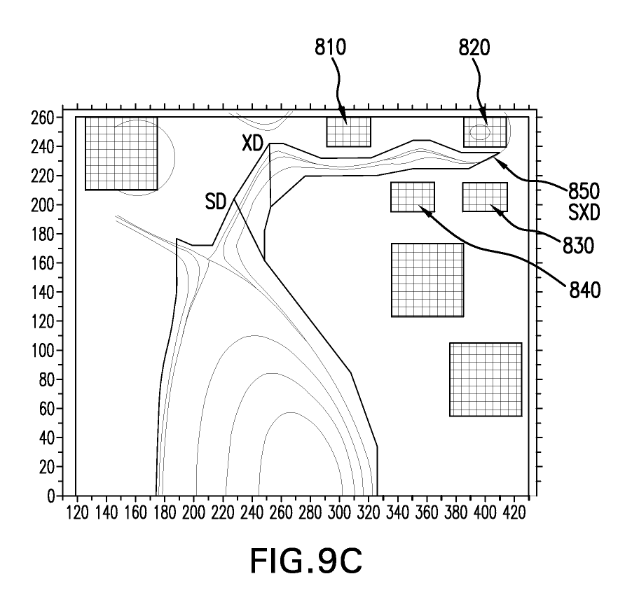

CORSICA™ equilibrium for an exemplary design, are shown in FIG. 9A. With reference to FIG. 9A, an exemplary design can comprise one extra poloidal field (PF) coil or current-carrying conductor 710 which can be shielded in a toroidal field (TF) corner (i.e., a section near the toroidal field coils wherein neutron flux is substantially lower than a non-shielded section of the device). Such a device can comprise a fertile material substantially adjacent to the toroidal chamber.

Various parameters for this device are listed in Table 4. The listed B Angle in Table 4 is θ, or the angle between the diverter plate 715 and the total magnetic field, B_{div}. The B Length, is the magnetic distance, or the magnetic line length, as discussed hereinabove. R_{div} is the diverter radius. Max area is the plasma wetted area on the diverter plate, as discussed hereinabove. The volume averaged temperature is represented by T in units of eV. The values for T listed in Table for are in reference to peak operation volume average temperatures. The results from Scrape-off layer plasma simulation calculations (SOLPS) are also presented.

With reference to Table 4 and FIG. 9A, various parameters for this embodiment are as follows: R_{div}=4.01 m, 1° Wet Area=5.6 m², B Length=61.8 m, B Length gain=4.0, MA-m ratio=1.62. As shown in FIG. 9A, both the standard diverter (SD) (R_{div}=2.3 m) and the X diverter (XD) (R_{div}=2.5 m) (see Kotschenreuther) have a smaller R_{div} than the disclosed diverter plate 715 (SXD). For comparative examples, Table 4 lists various parameters for the three aforementioned diverter designs, including a presently disclosed design.

TABLE 4
Parameters for standard divertor (SD), X divertor (XD), and an
embodiment of a disclosed divertor (SXD) for a reactor design.

| Div | B Angle | B Length | R_{div} | Max Area | T eV | SOLPS |
|---|---|---|---|---|---|---|
| Plate | Degrees | [m] | [m] | m² (at 1°) | at Peak | MW/m² |
| SD | 1.28 | 27.4 | 2.34 | 3.27 | 150 | 58 |
| XD | 0.93 | 39.7 | 2.51 | 3.51 | 150 | 28 |
| SXD | 1.2 | 61.6 | 4.01 | 5.61 | 10 | 18 |

For 5 mm wSOL at z = 0

CORSICA™ equilibrium for yet another exemplary design are shown in FIG. 9B, wherein a design comprises a diverter plate with two additional PF coils (720 and 730). In this example, more flux expansion and greater line length can be achieved by splitting a single diverter coil into two separate diverter coils. Such a device can comprise a fertile material substantially adjacent to the toroidal chamber.

Various parameters for this device are listed in Table 5. The listed B Angle in Table 5 is θ, or the angle between the diverter plate 740 and the total magnetic field, B_{div}. The B Length, is the magnetic distance, or the magnetic line length, as discussed hereinabove. R_{div} is the diverter radius. Max area is the plasma wetted area on the diverter plate, as discussed hereinabove. The volume averaged temperature is represented by T in units of eV. The values for T listed in Table for are in reference to peak operation volume average temperatures. The results from Scrape-off layer plasma simulation calculations (SOLPS) are also presented.

With reference to Table 5 and FIG. 9B, the parameters for this design are as follows: R_{div}=4.04 m 740, 1° Wet area=5.73 m², B Length=66.6 m, B Length gain=4.24, MA-m ratio=1.89. Table 5 show parameters for this exemplary split design, in comparison with a standard diverter (SD) and an X diverter (XD) (see Kotschenreuther).

TABLE 5
Parameters for standard divertor (SD), X divertor
(XD), and an embodiment of a disclosed divertor
740 (SXD) for a reactor design

| Div | B Angle | B Length | R_{div} | Max Area | T eV | SOLPS |
|---|---|---|---|---|---|---|
| Plate | Degrees | [m] | [m] | m² (at 1°) | at Peak | MW/m² |
| SD | 1.14 | 28.0 | 2.33 | 3.30 | 150 | 58 |
| XD | 1.07 | 42.0 | 2.51 | 3.56 | 150 | 28 |
| SXD | 1.00 | 66.6 | 4.04 | 5.73 | <8 | <18 |

For 5 mm wSOL at z = 0

CORSICA™ equilibrium for another exemplary design are shown in FIG. 9C, wherein there are four extra PF coils 810, 820, 830, and 840 (wherein 1 coil is split into 4 coils). Such a device can comprise a fertile material substantially adjacent to the toroidal chamber.

Various parameters for this device are listed in Table 4. The listed B Angle in Table 4 is θ, or the angle between the diverter plate 850 and the total magnetic field, B_{div}. The B Length, is the magnetic distance, or the magnetic line length, as discussed hereinabove. R_{div} is the diverter radius. Max area is the plasma wetted area on the diverter plate, as discussed hereinabove. The volume averaged temperature is represented by T in units of eV. The values for T listed in Table for are in reference to peak operation volume average temperatures. The results from Scrape-off layer plasma simulation calculations (SOLPS) are also presented.

With reference to Table 6 and FIG. 9C, the parameters for this design are as follows: R_{div}=3.95 m 850, 1° Wet area=5.57 m², B Length=73.6, B Length gain=4.69, MA-m ratio=1.72. It is also apparent that more B length can be obtained by changing coil locations. It will be apparent that the location of the PF coils can direct and/or shape the SOL to the diverter plate, and thereby expand or reduce the particle flux (heat flux) coming from the SOL.

TABLE 6
Parameters for standard divertor, X divertor, and a disclosed
divertor (split into four divertors) for a reactor design

| Div | B Angle | B Length | R_{div} | Max Area | T eV | SOLPS |
|---|---|---|---|---|---|---|
| Plate | Degrees | [m] | [m] | m² (at 1°) | at Peak | MW/m² |
| SD | 1.18 | 27.8 | 2.34 | 3.30 | 150 | 58 |
| XD | 0.92 | 40.3 | 2.51 | 3.54 | 150 | 28 |
| SXD | 1.0 | 73.6 | 3.95 | 5.57 | <5 | <18 |

For 5 mm wSOL at z = 0

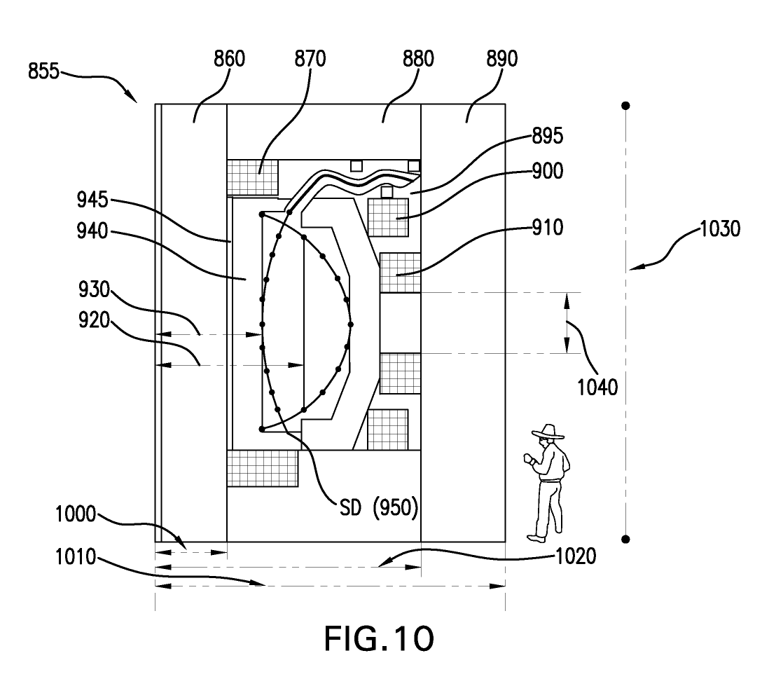

FIG. 10 shows, for example, a cross section of an exemplary fusion reactor 855 with a vertical height of about 7.15 m (1030) comprising components that can be used in a disclosed embodiment. Such a device can comprise a fertile material substantially adjacent to the toroidal chamber.

In this example, ohmic heating coils (OHCs) 945 are used to produce and/or heat the confined plasma, with a major plasma radius 920 of about 2.49 m, and with minor plasma radius of about 1.42 m. Extending from the central axis with a radius of about 1.78 m (930), is a blanket (i.e., the chamber walls) 940 that substantially encloses the plasma. The blanket shown is about 0.5 m thick.

The toroidal field (TF) center post 860 lies adjacent to the central axis, with a radius of about 1.2 m (1000), which is in physical communication with a TF wedge 880, the farthest radius of which extends about 4.35 m (1020) connected to TF outer verticals 890, the farthest radius of which extends about 5.72 m (1010). Exemplary poloidal field (PF) coils, 870, 900, and 910 inside the perimeter of the toroidal field, are positioned substantially adjacent to the fusion plasma. The distance 1040 between the two outermost (i.e., farthest away from the central axis) PF coils is about 1.0 m.

In this embodiment, a disclosed diverter plate 895 is shown substantially adjacent to a poloidal field coil 900. In the exemplary fusion reactor of FIG. 10, a standard diverter plate (SD) 950, as is known in the art, is shown in comparison to a disclosed diverter (SXD) 895. A standard diverter plate 950 configuration as shown in FIG. 10 can be used in combination with a disclosed diverter plate 895 configuration. It should be noted that the dimensions shown in FIG. 10 are exemplary in nature and variance of the dimensions or design of the fusion reactor is contemplated to be within the scope of various embodiments of the invention.

3. Modified Design of Future Machines

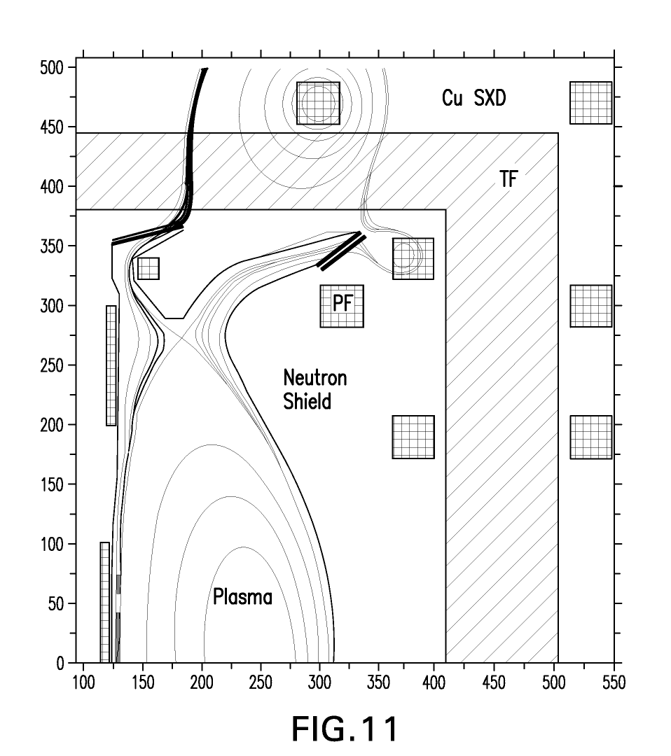

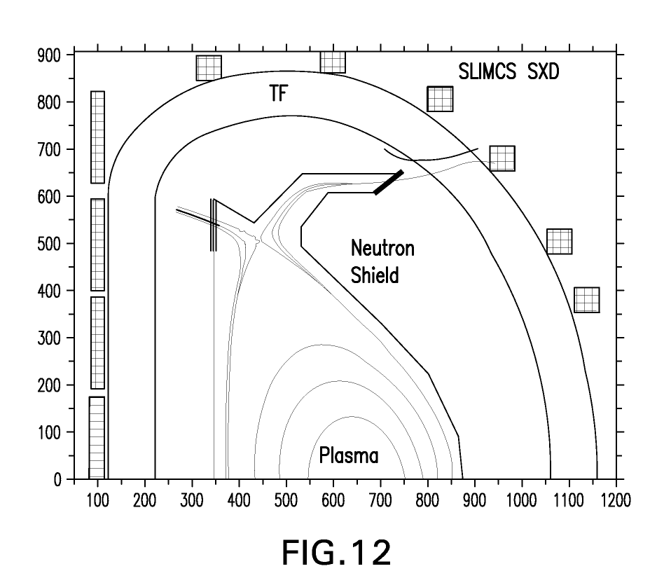

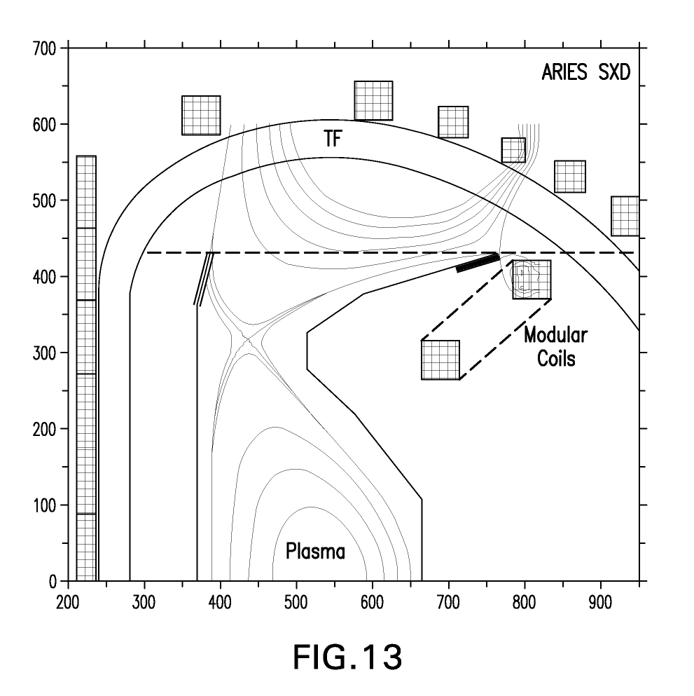

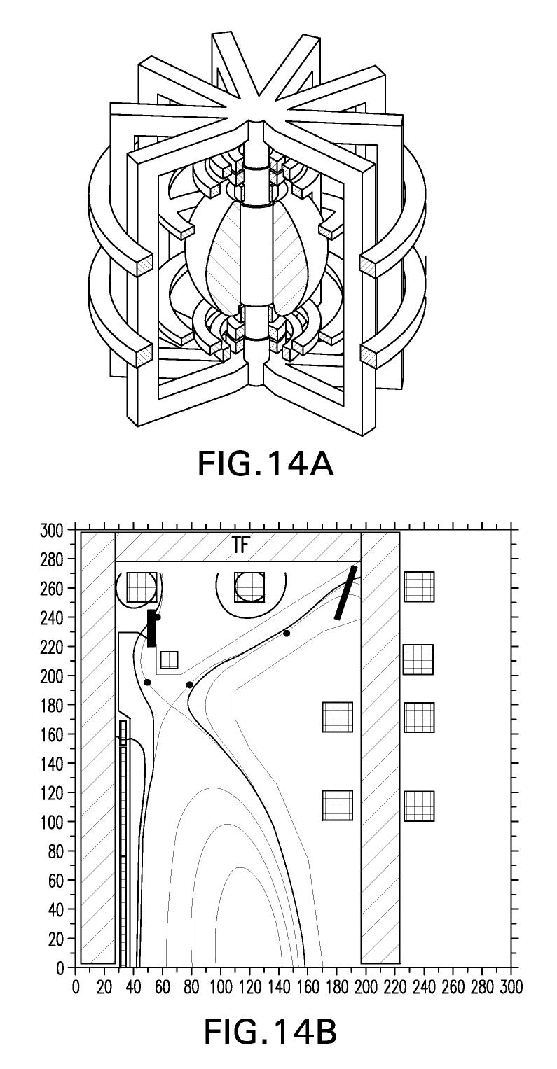

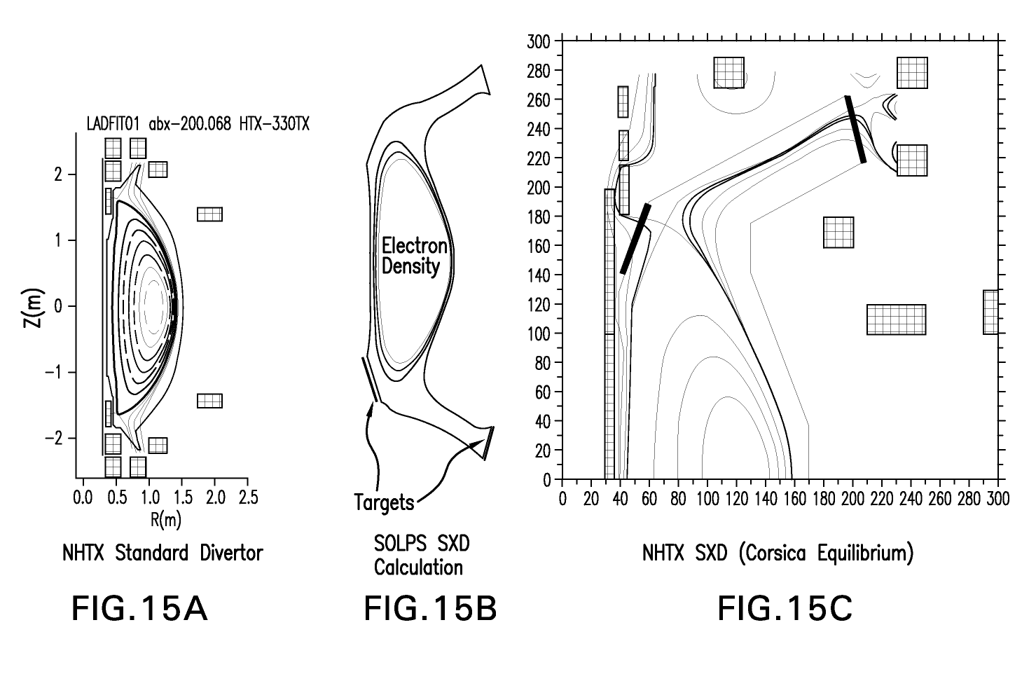

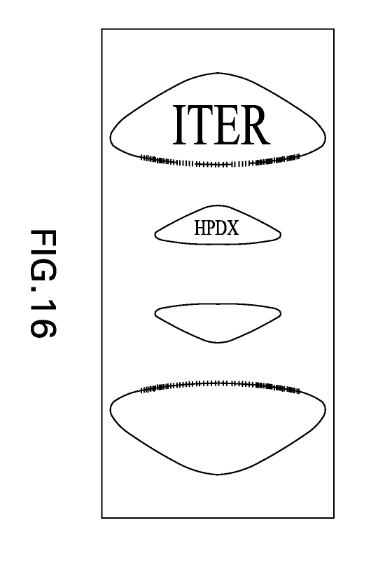

Using CORSICA™ (J. A. Crotinger, L. L. LoDestro, L. D. Pearlstein, A. Tarditi, T. A. Casper, E. B. Hooper, LLNL Report UCRLID-126284, 1997 available from NTIS PB2005-102154), MHD (magnetohydrodynamic) equilibrium can be generated for various future machine types, as presented herein. The results of a calculation for a Cu high power density reactor are shown in FIG. 11. The results of a calculation for a superconducting (SC) SLIM-CS reactor with small radial build for TF (assuming remote handling ability) are shown in FIG. 12. The results of a calculation for an ARIES-AT reactor (also SC) with radially large TF coils are shown in FIG. 13. For the ARIES design, it is apparent that an embodiment of a disclosed diverter design can be used wherein poloidal field (PF) coils are outside toroidal field (TF) coils. The design shown in FIG. 13, however, uses modular SC (superconducting) diverter coils that fit inside unused volume in the reactor, thereby enabling larger radial diverter extension. For the configurations in FIGS. 11, 10, and 11, the gains in R_{div}/Rₛₒₗ are 2, 1.7, and 2, respectively, while the line length goes up (over a standard diverter, discussed in more detail in Kotschenreuther) by factors of 5, 3, and 4, respectively. Such a device can comprise a fertile material substantially adjacent to the toroidal chamber.

It should be appreciated that, through experimentation with CORSICA™ equilibrium, a wide variety of plasma shapes (aspect ratios, elongations, triangularities, as defined hereinabove, etc.) can be accommodated with a disclosed embodiment. In some aspects, it is possible to modify the design of an existing or future reactor from a standard diverter design, to a disclosed diverter design with a small change in the number of coils and net applied power, while keeping the core geometry substantially unaffected. Thus, in one aspect, a disclosed diverter design can be applied to a known reactor configuration.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Although several aspects of the present invention have been disclosed in the specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims which follow, they are used only in a generic and descriptive sense, and not for the purposes of limiting the described invention.

What is claimed is:

1. A method of creating a radioisotope comprising:
providing a chemical element;
causing reactions of either (n,2n), (n,p), (n,d), or (n,α) in said chemical element using high energy neutrons created by fusion, wherein said fusion occurs in a compact fusion neutron source and said (n,2n), (n,p), (n,d), or (n,α) reactions create an isotope of said chemical element, or an isotope which has the said isotope is one of it's daughters

2. The method of claim 1, wherein the compact fusion neutron source further comprises a super-X diverter.

3. The method of claim 1, wherein the high-energy neutrons are produced by fusion of deuterium and tritium.

4. The method of claim 1, wherein providing a chemical element comprises providing one or more of Th232, Th228, Np237, P32, Ni63 or In111

5. The method of claim 1, wherein creating the radioisotope comprises creating one or more of U232, Th228, Pu236, P32, Ni63 or In111

6. The method of claim 1, wherein causing reactions of either (n,2n), (n,p), (n,d), or (n,α) in said chemical element comprises one of:
(for U232) Th232+n=>Th231+2n
Th231=>Pa231 (half life 25 hr)
Pa231+n=>Pa 232
Pa 232=>U232 (half life 1.3 days);
(for Th228) Th228 is a decay product of U232, so start by making U232 as above
U232=>Th228 (half life 74 yr);
(for Pu236) Np237+n=>Np236+2n
Np236=>Pu236 (half life 22 hrs);
(for P32) S32+n=>P32+p;
(for Ni63) Cu63+n=>Ni63+p; or
(for In111) Sn112+n=>Sn 111+2n
Sn 111=>In111 (half life 35 minutes)

7. A system for creating a radioisotope comprising:
a chemical element;
a compact fusion neutron source substantially adjacent to said chemical element, wherein high-energy neutrons from said compact fusion neutron source causes (n,2n), (n,p), (n,d), or (n,α) reactions in said chemical element creating an isotope of said chemical element, or an isotope which has the said chemical element as one of it's daughters

8. The system of claim 7, wherein the compact fusion neutron source further comprises a super-X diverter.

9. The system of claims 7, wherein the high-energy neutrons are produced by fusion of deuterium and tritium.

10. The system of claim 7, wherein the chemical element comprises providing one or more of Th232, Th228, or Np237, P32, Ni63 or In111

11. The system of claim 7, wherein creating the radioisotope comprises creating one or more of U232, Th228, or Pu236, P32, Ni63 or In111

12. The system of claim 7, wherein causing reactions of either (n,2n), (n,p), (n,d), or (n,α) in said chemical element comprises one of:
(for U232) Th232+n=>Th231+2n
Th231=>Pa231 (half life 25 hr)
Pa231+n=>Pa 232
Pa 232=>U232 (half life 1.3 days);
(for Th228) Th228 is a decay product of U232, so start by making U232 as above
U232=>Th228 (half life 74 yr);
(for Pu236) Np237+n=>Np236+2n
Np236=>Pu236 (half life 22 hrs);
(for P32) S32+n=>P32+p;
(for Ni63) Cu63+n=>Ni63+p; or
(for In111) Sn112+n=>Sn 111+2n
Sn 111=>In111 (half life 35 minutes)
